(19) United States
(12) Patent Application Publication
(10) Pub. No.: US 2024/0311709 A1
(43) Pub. Date: Sep. 19, 2024

(54) GENERATING AND PROVIDING DIGITAL NOTIFICATIONS FROM VEHICLE SERVICE FEATURES AND TRANSPORTATION MATCHING FEATURES UTILIZING AN INTELLIGENT RECOMMENDATION MODEL

(71) Applicant: Lyft, Inc., San Francisco, CA (US)

(72) Inventors: Ernesto Fernandez, Tavares, FL (US); Matan Zeev Goldschmiedt, Brooklyn, NY (US); Shaheen Lavie-Rouse, San Francisco, CA (US); Ying Liu, San Jose, CA (US); Brian John Salomaki, Tepoztlan (MX)

(21) Appl. No.: 18/186,047

(22) Filed: Mar. 17, 2023

(51) Int. Cl. G06Q 10/0631

(52) U.S. Cl. CPC G06Q 10/06311

(57) ABSTRACT

This disclosure describes a digital notification system that can extract rideshare features and vehicle service features and utilize computer implemented notification models to intelligently generate notifications. In particular, in one or more embodiments the digital notification system determines vehicle service features from various service management computing devices corresponding to various vehicle service stations. In addition, the digital notification system also monitors various provider computing devices to determine rideshare features for the various provider computing devices. Moreover, based on the vehicle service features and the rideshare features, the digital notification system generates a notification for a transportation matching application. Further, in response to generating the notification, the digital notification system provides for display via a graphical user interface of the transportation matching application the notification.

### BACKGROUND

Recent years have seen significant developments in digital systems that utilize mobile devices to provide digital notifications or alerts across computer networks. Indeed, the proliferation of web and mobile applications has enabled conventional systems to collect vast amounts of data that conventional systems then utilize to provide digital notifications across computer networks to mobile devices through mobile applications. Despite these recent advances, however, conventional digital systems continue to exhibit a number of drawbacks and deficiencies with regard to implementing computer devices.

For example, conventional systems suffer from accuracy problems within the digital notification space. Indeed, conventional notification systems generally draw from generalized vehicle data to provide recommendations or notifications. In particular, conventional notification systems can utilize generalized vehicle data such as the mileage of a vehicle to recommend changing a set of tires after a certain amount of time has passed. However, because they rely on such generalized digital data, conventional systems often fail to provide contextually tailored recommendations. Accordingly, conventional notification often provide inaccurate vehicle recommendations.

In addition, conventional notification systems also suffer from efficiency issues. Indeed, conventional notification systems typically require the utilization of multiple applications and user interfaces to provide pertinent vehicle information via client devices. In particular, conventional systems typically require excessive user interactions between multiple web applications and user interfaces to obtain sufficient information. To illustrate, a user of a client device may utilize a first web application or interface for tracking mileage of a vehicle, a second web application or interface for tracking vehicle maintenance costs, a third web application or interface for a maintenance schedule, and a fourth web application for making transportation or rideshare arrangements. Accordingly, conventional systems often require excessive user interactions and processing power (e.g., computer memory and computational resources).

Conventional systems also suffer from limited flexibility and functional capacity. For example, conventional notification systems often utilize a limited set of rigid, stale factors for surfacing digital notifications. Indeed, because conventional notification systems utilize rigid, generalized vehicle data to surface digital recommendations across computer networks, conventional systems are unable to flexibly customize or adapt digital notifications across different computing devices. Accordingly, conventional notification systems suffer from flexibility and functional capacity issues.

These, along with additional problems and issues, exist with conventional digital systems.

### SUMMARY

This disclosure describes one or more embodiments of methods, non-transitory computer-readable media, and systems that utilize computing models to generate intelligent notifications within a transportation matching application by determining vehicle service features and monitoring computing devices across computer networks to determine transportation matching features. In particular, in one or more embodiments the disclosed systems intelligently analyze vehicle service features and transportation matching features utilizing a notification model to determine accurate and personalized notifications to provide to the transportation matching application of a client device. For example, in one or more implementations, the disclosed systems utilize a machine learning model to analyze vehicle service features (such as vehicle maintenance patterns, vehicle maintenance costs, vehicle repair times, service vehicle types, vehicle accident information, and/or vehicle service station availability) and transportation matching features (such as transportation matching vehicle telematics data, transportation matching driver rating, transportation matching vehicle types, transportation matching driving route patterns, number of transportation matching provider devices for a geographic region, number of transportation matching requester devices for a geographic region, and/or provider transportation matching schedules). For instance, the disclosed system provides notifications that include at least one of a vehicle management notification, a transportation recommendation, or a transportation match notification. In this manner, the disclosed systems can flexibly determine contextually relevant digital notifications/recommendations within an efficient transportation matching application environment.

### BRIEF DESCRIPTION OF THE DRAWINGS

The detailed description refers to the drawings briefly described below.

FIG. 1 illustrates a block diagram of an environment for implementing a digital notification system in accordance with one or more embodiments.

FIG. 2 illustrates an example diagram of the digital notification system receiving vehicle service features and transportation matching features in accordance with one or more embodiments.

FIG. 3 illustrates an example diagram of the digital notification system monitoring various vehicle service features via a vehicle service system in accordance with one or more embodiments.

FIG. 4 illustrates an example diagram of the digital notification system monitoring various transportation matching features via a transportation matching system in accordance with one or more embodiments.

FIG. 5 illustrates an example diagram of the digital notification system training a vehicle recommendation machine learning model in accordance with one or more embodiments.

FIG. 6 illustrates an example diagram of the digital notification system generating various notifications in accordance with one or more embodiments.

FIG. 7 illustrates example graphical user interfaces provided by the digital notification system in accordance with one or more embodiments.

FIG. 8 illustrates an example series of acts for generating a notification in accordance with one or more embodiments.

FIG. 9 illustrates a block diagram of a computing device for implementing one or more embodiments of the present disclosure.

FIG. 10 illustrates an example environment for the digital notification system in accordance with one or more embodiments.

### DETAILED DESCRIPTION

This disclosure describes one or more embodiments of a digital notification system that utilizes computer models to intelligently generate notifications by monitoring and determining vehicle service features and transportation matching features. In particular, the digital notification system can determine vehicle service features from various service management computing devices that correspond with various vehicle service stations. Further, in one or more implementations, the digital notification system also determines transportation matching features by monitoring various provider computing devices via a transportation matching application. In doing so, the digital notification system can generate a notification with a notification model for providing the notification via a graphical user interface of a transportation matching application. According, the digital notification system can utilize efficient user interfaces to intelligently and accurately surface digital notifications that flexibly adapt to client devices based on monitored transportation matching and vehicle service features.

To illustrate, in one or more embodiments, the digital notification system draws from a variety of vehicle service features and transportation matching features to generate the notifications. For example, the digital notification system can determine vehicle service features that include vehicle maintenance patterns, vehicle maintenance costs, and/or vehicle repair down-times. Moreover, in some implementations, the digital notification system can determine service vehicle types, vehicle accident information, and/or vehicle service station availability to also intelligently analyze and surface notifications.

In addition to vehicle service features, the digital notification system can also monitor a variety of transportation matching features, such as transportation matching vehicle telematics data, transportation matching driver ratings, and/or transportation matching vehicle types to generate intelligent notifications. Moreover, in some implementations, the digital notification system can determine transportation matching features that includes transportation matching driving route patterns, number of transportation matching provider devices for a geographic region, a number of transportation matching requester devices for a geographic region, or provider transportation matching schedules.

The digital notification system can utilize transportation matching features in combination with vehicle service features to intelligently analyze and determine relevant notifications. For example, in one or more embodiments, the digital notification system utilizes a notification model, such as a trained machine learning model, to learn patterns and interactions between vehicle service features and transportation matching features to generate more accurate notifications. For instance, as mentioned, the digital notification system generates notifications which includes vehicle management notifications, transportation recommendations, and transportation match notifications which indicate a transportation match with a provider computing device. To illustrate, the digital notification system can determine correlations between transportation matching patterns, vehicle types, vehicle maintenance patterns, and vehicle service station availability to surface digital service notifications, digital offers, or vehicle safety/functionality notifications.

In one or more embodiments, the digital notification system surfaces the notifications within a transportation matching application. In particular, the digital notification system surfaces the notifications and provides relevant notifications within a graphical user interface of the application. Accordingly, a user of a client device can efficiently view relevant notifications within a single graphical user interface and within an application for arranging and managing transportation. Moreover, the digital notification system can surface notifications for both requester computing devices and provider computing devices. Thus, in one or more embodiments, the digital notification system intelligently generates notifications based on vehicle service features and/or transportation matching features.

As suggested above, the disclosed digital notification system provides several improvements or advantages over conventional systems. For instance, the digital notification system can improve upon accuracy of conventional systems by both determining vehicle service features from a plurality of service management computing devices and monitoring a plurality of provider and/or requester computing devices to determine transportation matching features. In particular, rather than merely relying on generalized vehicle data, the digital notification system draws from both vehicle service features that correspond with vehicle service stations and transportation matching features that correspond with provider computing devices and requester computing devices. In doing so, the digital notification system generates notifications that improve upon the accuracy of provided notifications as compared to conventional systems. To illustrate, because the digital notification system has access to transportation matching features and vehicle service features, the digital notification system can generate accurate and contextually tailored notifications.

In addition, the digital notification system improves upon the efficiency of conventional systems. In particular, the digital notification system improves upon efficiency by surfacing notifications and vehicle management information within a single client application and interface. Accordingly, the digital notification system can surface notifications and vehicle management information within a transportation matching application without requiring a user of the client device to navigate between multiple applications or interfaces. To illustrate, because the digital notification system draws upon both transportation matching features and vehicle service features, the digital notification system efficiently and extensively provides for relevant notifications within a single client application, thus reducing time and computation resources of implementing computing devices.

As another example, the digital notification system improves upon the flexibility and functionality of conventional systems. Indeed, by determining vehicle service features and transportation matching features to generate notifications, the digital notification system can extensively analyze and contextualize relevant notifications. In particular, the digital notification system can intelligently analyze via the notification model various recommendations to provide to a user of a client device. Accordingly, unlike conventional systems that are restricted to generalized vehicle data, the digital notification system draws from unique sources such as the transportation matching features and vehicle service features to hone in on efficient and accurate recommendations. Accordingly, the digital notification system improves upon the flexibility and functionality of conventional systems by utilizing computing models based on transportation matching features and vehicle service features.

As indicated by the foregoing discussion, the present disclosure utilizes a variety of terms to describe features and advantages of the digital notification system. For example, as used herein, the term “provider device” refers to a computing device associated with a transportation provider or driver (e.g., a human driver or an autonomous computer system driver) that operates a transportation vehicle. For instance, a provider device refers to a mobile device such as a smartphone or tablet operated by a provider—or a device associated with an autonomous vehicle that drives along transportation routes.

As suggested above, the term “requester device” refers to a computing device associated with a requester that submits a transportation request to a transportation matching system. For instance, a requester device receives interaction from a requester in the form of user interaction to submit a transportation request. After the transportation matching system matches a requester (or a requester device) with a provider (or a provider device), the requester can await pickup by the provider at a predetermined pick-up location. Upon pick-up, the provider transports the requester to a drop-off location specified in the requester's transportation request. Accordingly, a requester may refer to (i) a person who requests a request or other form of transportation but who is still waiting for pickup or (ii) a person whom a transportation vehicle has picked up and who is currently riding within the transportation vehicle to a drop-off location.

As mentioned above, the digital notification system generates a notification and provides for display the notification within a transportation matching application. As used herein, the term “transportation matching application” refers to a client application utilized for matching requesters and providers. In particular, the transportation matching application matches requester devices and provider devices based on transportation requests made by a requester device and the availability of provider devices. To illustrate, the transportation matching application includes a variety of features such as transportation matching options and options for viewing notifications.

As used herein, the term “transportation request” refers to a request from a requesting device (i.e., a requester device) for transport by a transportation vehicle. In particular, a transportation request includes a request for a transportation vehicle to transport a requester (i.e., requester device) or a group of individuals from one geographic area to another geographic area. A transportation request can include information such as a pick-up location, a destination location (e.g., a location to which the requester wishes to travel), a request location (e.g., a location from which the transportation request is initiated), location profile information, a requester rating, or a travel history. As an example of such information, a transportation request may include an address as a destination location and the requester's current location as the pick-up location. A transportation request can also include a requester device initiating a session via a transportation matching application and transmitting a current location (thus, indicating a desire to receive transportation services from the current location).

As mentioned above, the digital notification system determines vehicle service features. As used herein, the term “vehicle service features” refers to characteristics or features pertaining to maintaining or servicing a vehicle. In particular, vehicle service features includes various features such as vehicle down-times, vehicle service station availability, service vehicle type, vehicle maintenance costs, maintenance patterns, and vehicle accident information. As further explained below, the digital notification system monitors a variety of sources to determine the vehicle service features.

As also mentioned, in some implementations the digital notification system determines vehicle service features from a plurality of service management computing devices. As used herein, the term “service management computing devices” refers to a computing device associated with a vehicle service station. In particular, service management computing devices can include computing devices corresponding with automotive shops and automotive part manufacturers. Thus, for instance a service management computing device can refer to client devices utilized by service technicians, computing devices monitoring and managing service bays of a service station, devices that monitor vehicle service parts and inventory, and/or server devices that collect and manage information regarding one or more vehicle service stations. As used herein, the term “vehicle service stations” refers to locations that perform services for vehicles, produce or distribute vehicle parts, and/or keep vehicle service records and costs.

As mentioned, the digital notification system determines transportation matching features. As used herein, the term “transportation matching features” refers to features pertaining to requesters making transportation requests, providers fulfilling transportation requests, and/or matches with various modes of transport for requesters making transportation requests such as matches with bikes, scooters, and other available modes of transport. In particular, transportation matching features include transportation matching vehicle telematics data, transportation matching driver ratings, transportation matching vehicle types, transportation matching driving route patterns, number of transportation matching provider devices for a geographic region, number of transportation matching requester devices for a geographic region, and/or provider transportation matching schedules. To illustrate, the digital notification system monitors a plurality of provider computing devices and/or requester computing devices via a transportation matching application to determine transportation matching features. To further emphasize, transportation matching features includes the digital notification system monitoring a plurality of computing devices participating in a transportation matching ecosystem to determine various features. Moreover, the term transportation matching features also includes ridesharing features. Specifically, ridesharing features covers a ridesharing ecosystem with provider computing devices and requester computing devices.

As mentioned, the digital notification system generates a notification to provide for display. As used herein, the term “notification” refers to an indication provided to a client application of a client device that provides a transportation recommendation, suggestion, a direction related to one or more transportation vehicles, a vehicle management notification, or a transportation match notification. In particular, notifications can include offer notifications and vehicle maintenance recommendations. To illustrate, the digital notification system generates notifications based on vehicle service features and transportation matching features.

Furthermore, as just mentioned above, the digital notification system generates the notification which includes the vehicle management notification. For example, the term “vehicle management notification” includes a digital notification pertaining to maintaining, operating, insuring, or servicing a vehicle. In particular, the vehicle management notification can include a notification to visit a vehicle service station, a notification to change tires, a notification for an oil change, or any other notification relating to the upkeep or maintenance of a vehicle.

Moreover, as also mentioned above, the digital notification system generates the notification which includes a transportation recommendation. For example, the term “transportation recommendation” includes a recommendation or notification for a vehicle or mode of transportation. For instance, a transportation recommendation can include a recommendation to the client device whether to utilize a personal vehicle or to utilize a transportation matching vehicle (such as a vehicle operated by a provider, a bike, a scooter, or public transit). In particular, the transportation recommendation includes the digital notification system analyzing transportation matching data and vehicle service feature data to make an intelligent determination. For instance, the intelligent determination for the transportation recommendation includes considering cost-effectiveness, safety, time-effectiveness, vehicle service needs, and a myriad of factors related to optimizing transportation matching ecosystems and the use of a personal vehicle.

Additionally, as also mentioned, the digital notification system generates the transportation match notification. For example, the term “transportation match notification” includes the digital notification system generating a match between a requester computing device and a provider computing device. In particular, the transportation match notification includes the digital notification system analyzing various factors such as the aforementioned transportation matching features and the vehicle service features to make an intelligent determination. For instance, the digital notification system can determine a match between a requester device and a provider device based on considering safety (e.g., vehicle upkeep), requester computing device preferences (e.g., historical ratings, etc.), and cost-effectiveness. In short, the transportation match notification can consider vehicle service features and transportation matching features to improve transportation matches between requester computing devices and provider computing devices.

As mentioned above, the digital notification system utilizes a notification model to generate notifications. As used herein, the term “notification model” refers to a computer-implemented model for generating a notification. To illustrate, a notification model can include a computer-implemented model for intelligently analyzing different features to provide a notification. In one or more embodiments, a notification model includes a machine learning model. As used herein, the term “machine learning model” refers to a computer algorithm or a collection of computer algorithms that automatically improve for a particular task through experience based on use of data. For example, machine learning model, includes a computer algorithm that can be trained and/or tuned based on inputs to approximate unknown functions. As another example, a machine learning model can include a computer algorithm with branches, weights, or parameters that change based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

In some embodiments, the digital notification system utilizes a neural network to generate digital notifications based on the vehicle service features and the transportation matching features. For example, a neural network refers to a machine learning model of interconnected artificial neurons (e.g., organized in layers) that communicate and learn to approximate complex functions and generate outputs based on a plurality of inputs provided to the neural network. In some cases, a neural network refers to an algorithm (or set of algorithms) that implements deep learning techniques to model high-level abstractions in data. For example, a neural network includes a multi-layer perceptron, a transformer neural network, a convolutional neural network, a recurrent neural network (e.g., an LSTM), a graph neural network, or a generative adversarial neural network.

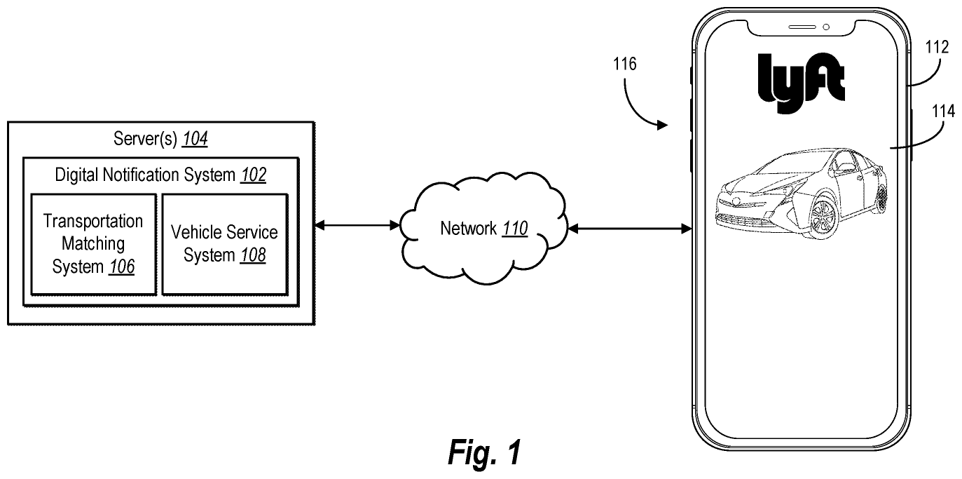

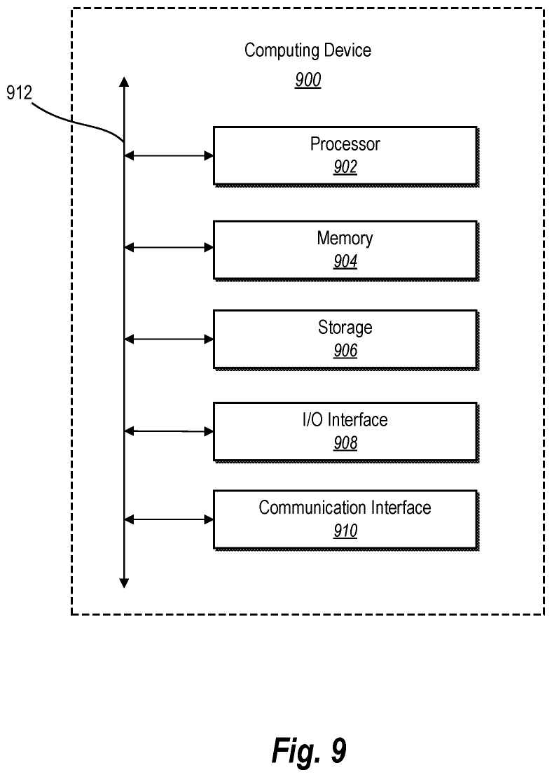

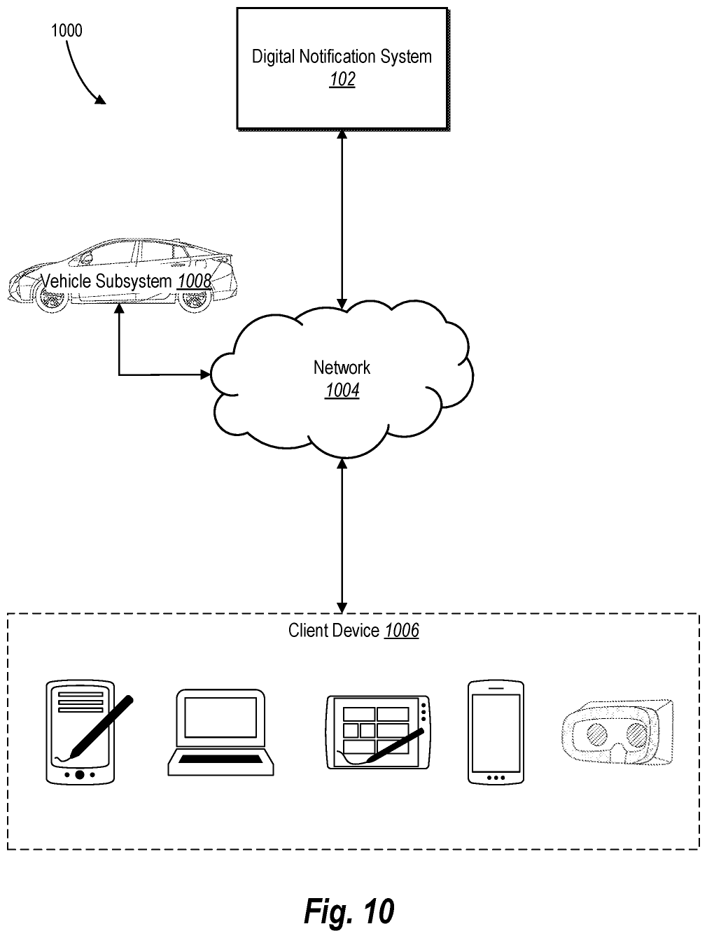

Additional detail regarding the digital notification system will now be provided with reference to the figures. In particular, FIG. 1 illustrates a block diagram of a system environment for implementing a digital notification system 102 in accordance with one or more embodiments. As shown in FIG. 1, the environment includes server(s) 104 housing a transportation matching system 106 and a vehicle service system 108 as sub-components of the digital notification system 102. The environment of FIG. 1 further includes a client device 112 (including a client application 116) and a network 110. Furthermore, in one or more embodiments, the client device 112 includes an infotainment screen (e.g., built into a dashboard, a seat, a ceiling, or other surface of a vehicle). The server(s) 104 can include one or more computing devices to implement the digital notification system 102. Additional detail regarding the illustrated computing devices (e.g., the server(s) 104 and the client device 112) is provided with respect to FIGS. 9-10 below.

As shown, the digital notification system 102 utilizes the network 110 to communicate with the client device 112 (e.g., a requester client device and/or a provider client device). The network 110 may comprise any network described in relation to FIGS. 9-10. For example, the digital notification system 102 communicates with the client device 112 to generate notifications and provide for display the notifications on the client device 112. Indeed, as already mentioned, the digital notification system 102 includes the sub-components of the transportation matching system 106 and the vehicle service system 108. In particular, the transportation matching system 106 or the digital notification system 102 can receive a transportation request from a requester device and can provide requester information to various provider device, such as a requested location (e.g., a requested pickup location and/or a requested drop-off location), a requester identification (for a requester corresponding to the client device 112), and a requested pickup time. In some embodiments, per device settings, the transportation matching system 106 or the digital notification system 102 receives device information from various provider devices and various requester devices, such as location, driving patterns, transportation matching telematics data, transportation matching schedules, a number of requests in a geographic location, transportation matching driver ratings, and transportation matching vehicle types.

Furthermore, the vehicle service system 108 or the digital notification system 102 can monitor various vehicle services (e.g., auto shops, manufacturers, vehicle record entities) to receive a variety of vehicle service features. Indeed, the vehicle service system 108 can communicate with client device 112 to arrange for vehicle maintenance, communicate during vehicle maintenance (e.g., provide maintenance updates via one or more user interfaces), provide vehicle maintenance payment, provide indicators regarding completed vehicle maintenance, or provide information regarding upcoming or needed vehicle maintenance. As mentioned above, the vehicle service system 108 can also monitor and collect service features regarding vehicle maintenance.

To facilitate providing notifications to client devices, in some embodiments, the digital notification system 102 communicates with the client device 112 and other client devices connected to the transportation matching system 106 and the vehicle service system 108. As indicated by FIG. 1, the client device 112 includes the client application 116. In many embodiments, the digital notification system 102 communicates with the client device 112 through the client application 116 to, for example, generate notifications to provide within a graphical user interface 114 of the client application 116.

As indicated above, the digital notification system 102 can provide (and/or cause the client device 112 to display or render) visual elements within the graphical user interface 114 associated with the client application 116. For example, the digital notification system 102 can provide a notification for display within the client application 116.

Moreover, the digital notification system 102 provides a user interface via the client device 112 that includes selectable options for various types of transportation requests (e.g., a standard transportation request type, a time priority airport transportation request type, and/or a flexible time delay airport transportation request type), vehicle data inputs, and selections for viewing or dismissing notifications. The digital notification system 102 can provide a user interface for provider requester devices (e.g., a user interface that identifies one or more requester devices and navigation instructions to fulfill transportation requests) and/or requester devices (e.g., a user interface that identifies one or more provider devices, ride types, transportation value to obtain transportation services).

Although FIG. 1 illustrates the environment having a particular number and arrangement of components associated with the digital notification system 102, in some embodiments, the environment may include more or fewer components with varying configurations. For example, in some embodiments, the digital notification system 102 can communicate directly with the client device 112, bypassing the network 110. In these or other embodiments, the digital notification system 102 can be housed (entirely on in part) on the client device 112. Additionally, the digital notification system 102 can include or communicate with a database for storing information, such as various machine learning models, historical data (e.g., historical provider device and/or requester device patterns), transportation requests, and/or other information described herein. Moreover, although FIG. 1 illustrates a single client device 112, the client device 112 is representative of a variety of client devices (e.g., thousands or millions of provider devices and requester devices) that interact with the digital notification system 102, the transportation matching system 106, and/or the vehicle service system 108.

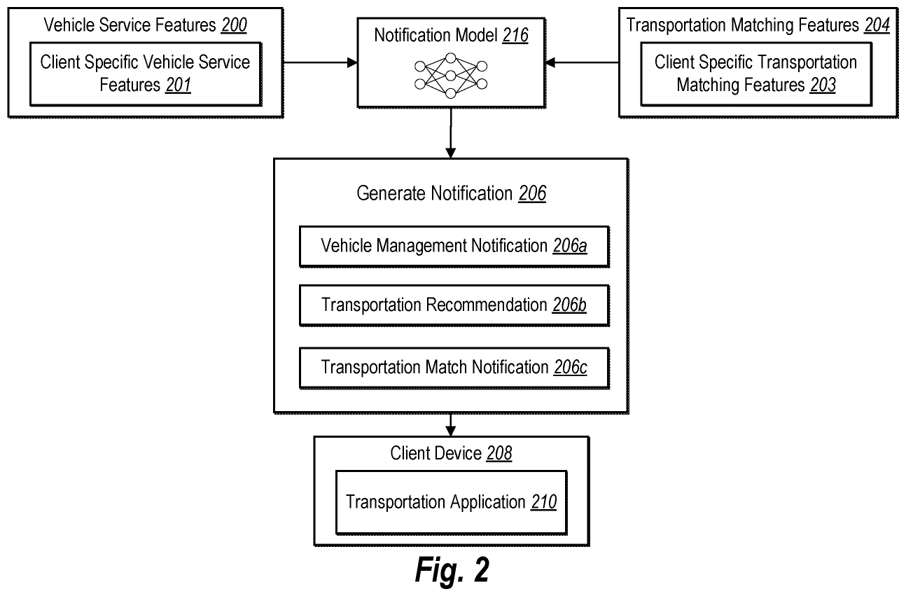

As mentioned, in certain embodiments, the digital notification system 102 intelligently generates and provides notifications to client devices via a transportation matching application. For example, FIG. 2 illustrates an overview of the digital notification system 102 receiving vehicle service features 200 and transportation matching features 204 to generate a notification 206 utilizing a notification model 216 in accordance with one or more embodiments.

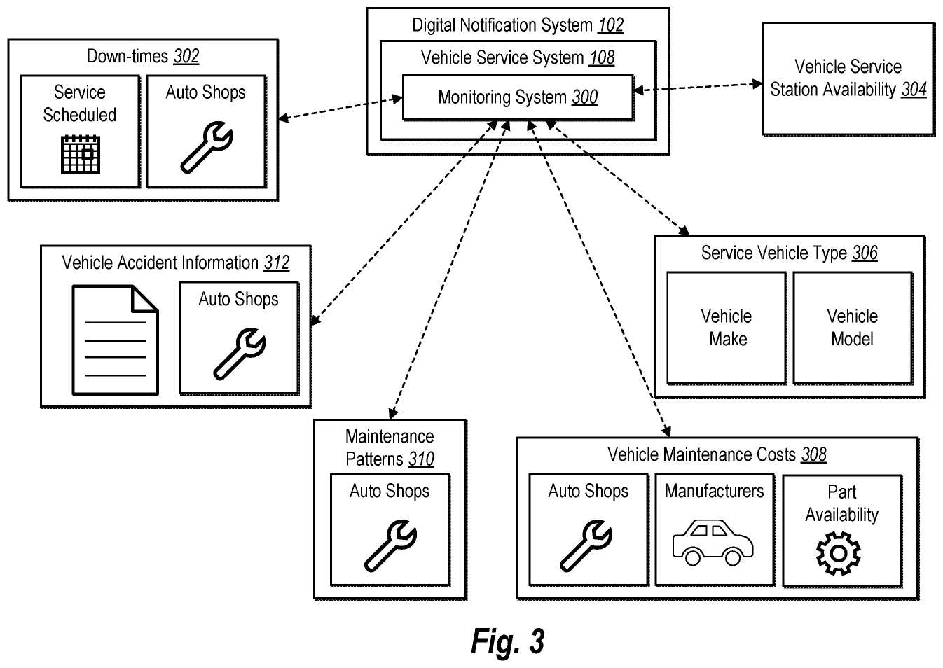

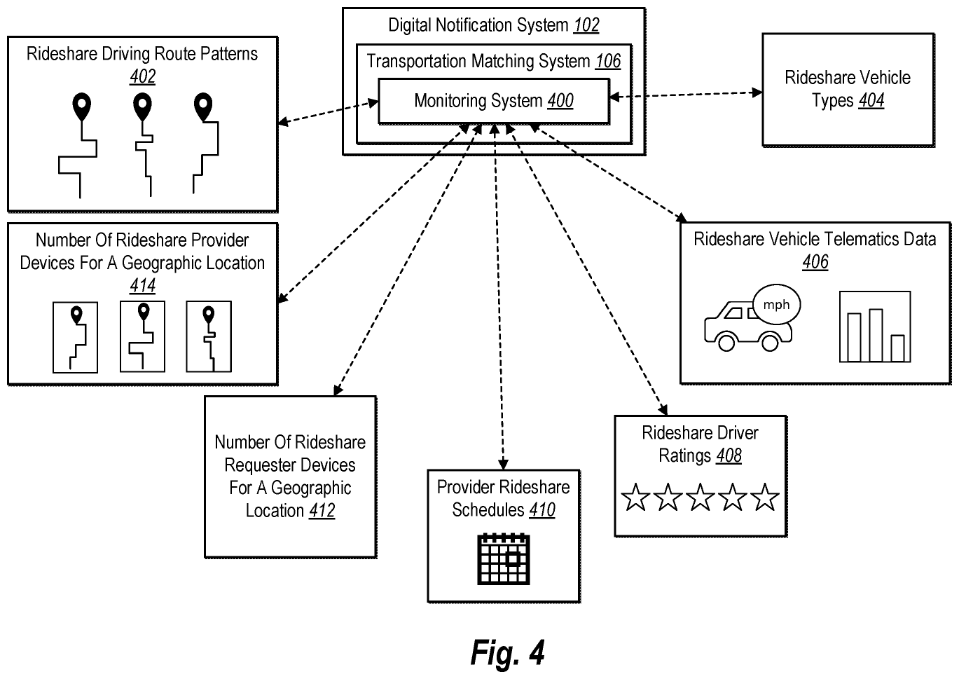

As shown in FIG. 2, the digital notification system 102 receives vehicle service features 200 and transportation matching features 204. The digital notification system 102 monitors computing devices of a vehicle service system and/or a transportation matching system to determine the vehicle service features 200 and the transportation matching features 204. For example, the digital notification system 102 can interact with service management computing devices that manage scheduling, parts, labor, and invoicing for vehicle service stations to determine the vehicle service features 200. Similarly, the digital notification system 102 can interact with provider computing devices that provide transportation services and/or requester computing devices that request and receive transportation services to determine the transportation matching features 204. Additional detail regarding the vehicle service features 200 and the transportation matching features 204 are provided below (e.g., in relation to FIGS. 3-4).

As shown in FIG. 2, the vehicle service features 200 and the transportation matching features 204 can include client specific vehicle service features 201 and client specific transportation matching features 203 (e.g., features that correspond to a specified client device or user). The digital notification system 102 can also determine the client specific vehicle service features 201 and the client specific transportation matching features 203 from service management computing devices, provider computing devices, and/or transportation matching computing devices. Indeed, upon receiving permissions from a client device, the digital notification system 102 can identify specific vehicle maintenance and transportation matching information corresponding to a user account.

In some implementations, the digital notification system 102 can query a client device associated with the user for vehicle service features and/or transportation matching features. In some embodiments, the digital notification system 102 automatically determining the client specific features based on vehicle records.

As just mentioned, in one or more embodiments, the digital notification system 102 receives the client specific vehicle service features 201 and client specific transportation matching features 203 based on the digital notification system 102 providing a query within the transportation matching application. For example, in response to a user of the client device 208 executing the transportation matching application 210, the digital notification system 102 generates and provides a set of client specific feature questions. In particular, the digital notification system 102 can provide to the user of the client device 208 an option to receive user input reflecting responses to questions.

In one or more embodiments the digital notification system 102 utilizes a set of queries to receive client specific vehicle service features 201. For example, the digital notification system 102 can request vehicle type (e.g., vehicle make and/or vehicle model, last oil change, service maintenance history (e.g., last time brakes were changed), and vehicle insurance information.

In some embodiments, the digital notification system 102 provides an option to automatically capture information (e.g., via a digital camera). For example, the digital notification system 102 can provide an option to utilize a digital camera to respond to a query. In particular, the client device can utilize a camera device to capture a digital image portraying a vehicle, and the digital notification system 102 intelligently determines one or more responses to a query. To illustrate, the user of the client device can capture the VIN number of the vehicle and the digital notification system 102 can intelligently utilize the VIN number to determine vehicle type, vehicle color, vehicle age, accident history, etc.

As mentioned above, in one or more implementations, the digital notification system 102 determines the client specific transportation matching features 203 by a user of the client device 208 sharing transportation matching data. For example, the digital notification system 102 can provide to the user of the client device 208 an option to share data corresponding with their transportation matching account (e.g., account information corresponding to the user as a driver and/or a rider). In particular, the digital notification system 102 receives permission to access the user of the client device's transportation matching account and determines relevant transportation matching data such as provider transportation matching schedule, transportation matching driving route patterns, and transportation matching driver ratings.

In some implementations, the digital notification system 102 utilizes name registration corresponding with the user of the client device to determine vehicle information. In particular, by signing into the transportation matching application, the user of the client device can provide a name, location, and email address. Based on the name, location, and email address (and upon receiving authorization from the client device to access additional information), the digital notification system 102 can request vehicle records. For instance, upon receiving permission/authorization, the digital notification system can contact various entities, such as service stations, public records, or insurance companies to determine potential vehicle information corresponding with the user of the client device. To illustrate, the digital notification system 102 can determine potential vehicle information associated with the user of the client device and provide a notification to the user of the client device to confirm whether any of the determined vehicle information is correct.

As previously mentioned, the digital notification system 102 utilizes the notification model 216 to perform an act of generating the notification 206. For example, after identifying the aforementioned features, the digital notification system 102 intelligently analyzes the features utilizing the notification model 216.

The notification model 216 can include a variety of computer-implemented models to intelligently generate notifications. For example, one or more embodiments the notification model 216 includes a heuristic model that applies logical rules to generate contextual notifications based on the features discussed above.

For example, the notification model 216 can include a variety of different rules that analyze input features and select a corresponding digital notification. Thus, specific feature combinations or interactions cause the notification model 216 to select a first digital notification whereas a different set of feature combinations or interactions will cause the notification model 216 to select a different notification. For example, the notification model 216 can utilize logical rules that recommend an oil change at a specific location in response to detecting that vehicle maintenance patterns and service station availability align with a provider transportation matching schedule. Thus, the digital notification system 102 utilizes a predetermined mapping between the presence of specific feature interactions or patterns to generate the notification 206.

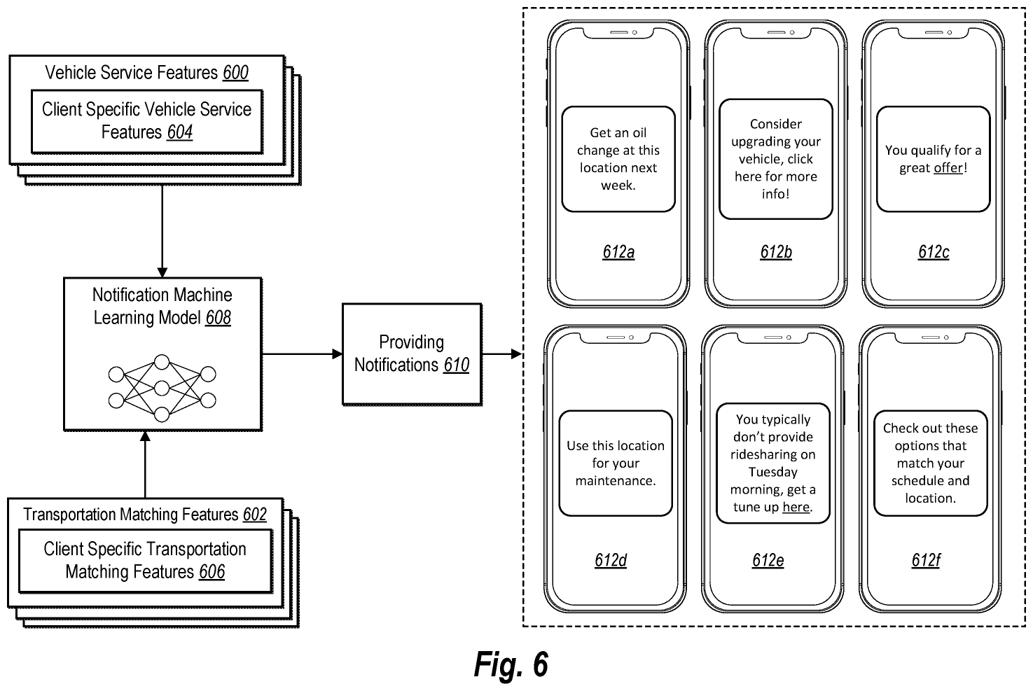

The digital notification system 102 can determine the logistical rules by analyzing historical features and user interactions with digital notifications. The digital notification system 102 can compare current/client-specific features to these logistical rules based on historical features to surface digital notifications. For example, the digital notification system 102 can learn historical or average transportation matching routes, vehicle maintenance procedures, transportation matching driver ratings, etc., and then utilize historical features as logical rules to surface digital notifications based on current features corresponding to a particular client device. For instance, historical information can indicate that providers having above average transportation matching ratings with needed service maintenance are likely to respond to digital notifications so long as service station maintenance availability is high. Thus, if a transportation matching driver rating is above a historical benchmark, a maintenance deadline for a vehicle type is above historical service benchmark, and a measure of vehicle service station availability is below a historical benchmark, the digital notification system 102 can surface a digital notification regarding maintenance at the available service station. The digital notification system 102 can combine a variety of features and enforce logical rules to generate digital notifications (e.g., as described in additional detail below in relation to FIG. 6).

As also mentioned above, in one or more implementations the digital notification system 102 utilizes a notification model 216 that includes a machine learning model. In particular, the digital notification system 102 can utilize a vehicle recommendation machine-learning model to determine the notification 206 by inputting the vehicle service features 200, the transportation matching features 204, the client specific vehicle service features 201, and the client specific transportation matching features 203 into the vehicle recommendation machine-learning model. For example, the vehicle recommendation machine-learning model can receive the aforementioned features, where a combination of the features can indicate a relevant notification. In particular, the digital notification system 102 can utilize the vehicle recommendation machine-learning model to analyze vehicle service features 200 and transportation matching features 204 and can encode the information (e.g., using one hot encoding, an encoding layer, or a vector mapping). The vehicle recommendation machine-learning model can then process the encoding utilizing a machine learning model architecture (e.g., neural network layers or decision tree branches) to generate the notification 206.

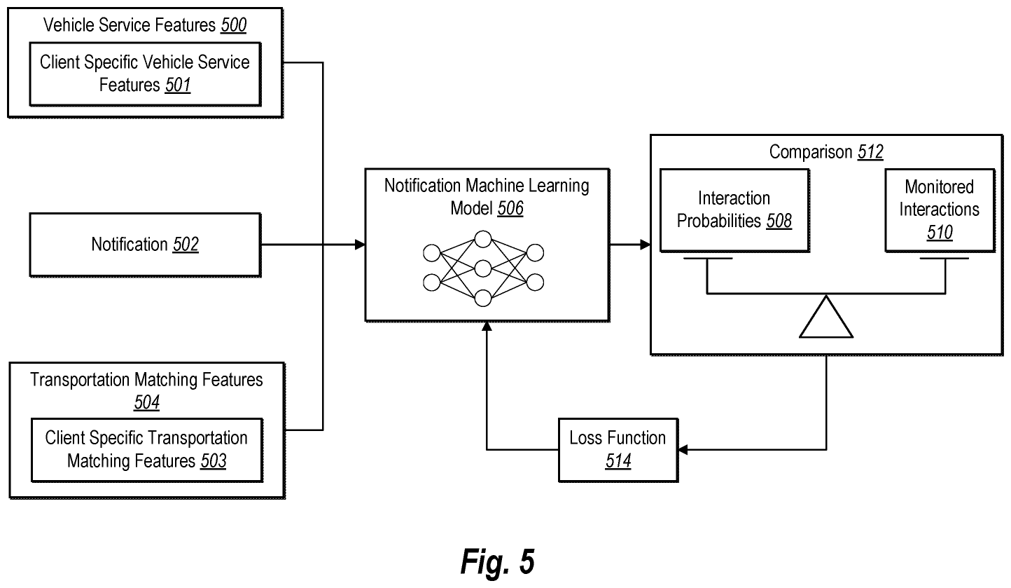

To illustrate, in some implementations the notification model 216 includes a convolutional neural network that predicts a probability of interaction with a particular notification class. The convolutional layers of the convolutional neural network can process the input features at different levels of abstraction to generate a predicted notification. Similarly, in some implementations, the notification model 216 includes a recurrent neural network that analyzes the features (and/or previous notifications) in sequence and predicts a probability of interaction with notifications based on the sequence of previous features (or notifications). Similarly, the notification model 216 can include a decision tree with learned weights at branches of the decision tree that process the input features to ultimately select a particular notification. Additional details regarding training the vehicle recommendation machine learning model are given below in the description of FIG. 5.

In some embodiments, the notification model 216 includes a reinforcement learning model, such as a Markov Decision Process. For example, the digital notification system 102 can utilize a notification model that includes a learner model and a decision-making (i.e., agent) model. The agent model selects an action for a given state, which an environment reacts to in transitioning to a new state with a corresponding reward. Based on historical patterns reflected in the features above, the digital notification system 102 can learn the probability of state changes and rewards associated with a particular action. Thus, in one or more embodiments, the notification model 216 learns the probability of a different state transitions and rewards (e.g., interactions with digital notifications) by analyzing the historical features described above. Moreover, the notification model 216 can then determine a current state for a particular client device based on the client-specific features and select a particular action (e.g., notification) to move to an improved state and corresponding reward. Thus, the notification model 216 can include a reinforcement learning model utilized to select digital notifications that will improve (e.g., maximize) the probability of a particular reward or outcome (e.g., interaction with a digital notification or performing an action based on the notification).

As already mentioned above, based on the notification model 216, the digital notification system 102 generates the notification 206. For example, in some instances, the digital notification system 102 generates multiple notifications based on the aforementioned features received by the notification model 216. In particular, the digital notification system 102 can determine an interaction probability (or relevance probability or other relevance score) for each of the generated notifications. Furthermore, as shown, FIG. 2 illustrates the notification 206 including a vehicle management notification 206a, a transportation recommendation 206b, and/or a transportation match notification 206c.

In one or more embodiments, the digital notification system 102 provides the notifications to a client device based on the interaction probability. In particular, the digital notification system 102 can provide the notifications based on a highest interaction probability. To illustrate, the digital notification system 102 provides a first notification with the highest interaction probability to the client device 208 via the transportation matching application 210. Based on the client device 208 viewing the first notification, the digital notification system 102 then presents a second notification with the second highest interaction probability.

In one or more embodiments, the digital notification system 102 can apply a threshold in providing digital notifications. In particular, the digital notification system 102 can compare an interaction probability with a probability threshold (e.g., 70%) in providing digital notifications. To illustrate, the digital notification system 102 filters out notifications with an interaction probability that fails to satisfy the probability threshold.

In one or more embodiments, the digital notification system 102 can generate contingency mappings between various notifications such that if a user of the client device 208 via the transportation matching application 210 interacts with a first notification, the digital notification system 102 then presents a second notification. To illustrate, the first notification can include a notification to use a specified location for vehicle maintenance. If the user of the client device 208 interacts with the first notification, then the digital notification system 102 presents a second notification that includes a day and time for bringing a vehicle for maintenance at the specified location.

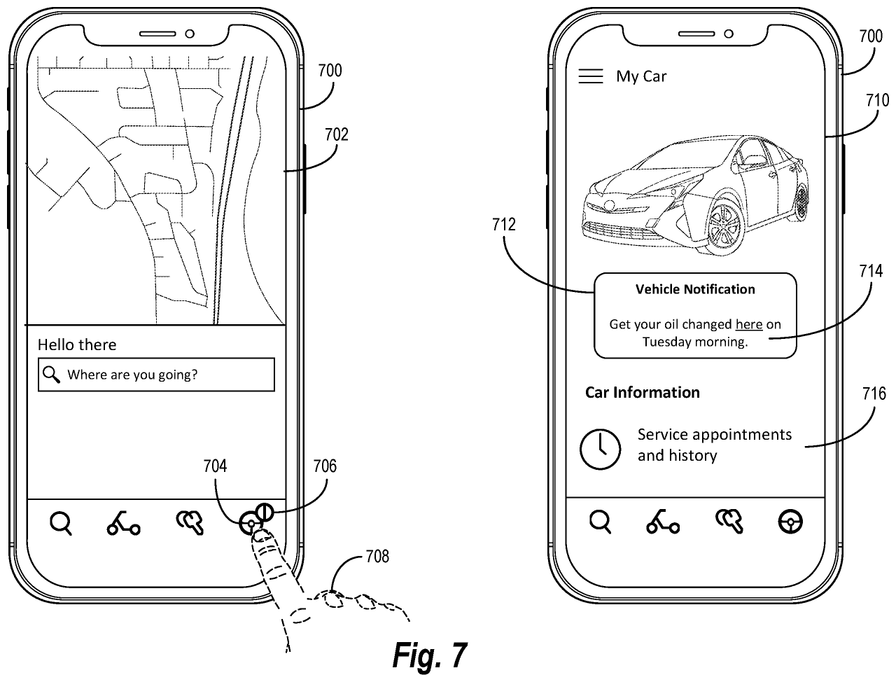

As alluded to above, the digital notification system 102 generates the notifications and provides the notifications for display to a client device. For example, the digital notification system 102 provides for display the generated notification 206 to the client device 208 via the transportation matching application 210. In particular, the digital notification system 102 provides for display via the transportation application at least one of the vehicle management notification 206a, the transportation recommendation 206b, and/or the transportation match notification 206c. Additional details regarding graphical user interfaces of the transportation matching application 210 are provided below (e.g., in relation FIG. 7).

As discussed above, in some implementations the digital notification system 102 determines vehicle service features by monitoring various entities. For example, FIG. 3 illustrates the digital notification system 102 monitoring various devices that are a part of a vehicle service system 108. In particular, FIG. 3 illustrates an overview of the digital notification system 102 interacting with the vehicle service system 108 to determine vehicle service features.

As illustrated by FIG. 3, the digital notification system 102 via the vehicle service system 108 monitors and extracts vehicle service features from various devices. For example, the digital notification system 102 monitors service management computing devices to determine down-times 302. For example, the down-times 302 includes a period in which a vehicle is inoperable (or unavailable to a driver/owner). In particular, as illustrated by FIG. 3, the digital notification system 102 can monitor service management computing devices of various service stations to determine the amount of time that various vehicles (and vehicle types) are inoperable for various maintenance types. To illustrate, the digital notification system 102 can analyze service schedules and/or vehicle check-in/check-out times via service management computing devices to determine that down-times 302 associated with getting an oil-change is approximately 90 minutes. In making a determination of the down-times 302, the digital notification system 102 can subsequently generate relevant and contextualized notifications based on the down-times 302.

In addition, FIG. 3 shows the digital notification system 102 determining vehicle service station availability 304. For example, vehicle service station availability 304 includes availability of service for vehicles, operating hours for vehicle service stations, vehicle part availability, and/or vehicle labor availability. For example, the digital notification system 102 determines the vehicle service station availability by interacting with service management computing devices of various service stations or vehicle part managers to determine open bays, open maintenance slots, available parts, and available operators or service technicians. For instance, the digital notification system 102 can utilize camera devices to determine service station availability (e.g., by identifying open bays), can utilize scheduling applications to identify open maintenance slots, can utilize inventory tracking software to determine available parts, and access technician scheduling data to determine technician availability. Thus, the digital notification system 102 can determine vehicle service station availability 304 for a particular geographic location relating to parts, labor, and general operating hours.

Further, FIG. 3 shows the digital notification system 102 monitoring service vehicle type 306. For example, service vehicle type 306 includes vehicle make, vehicle model, and/or vehicle year. In particular, the digital notification system 102 determines vehicle make and model for vehicle service maintenance activities to identify patterns corresponding with specific makes and models. Based on identified patterns, the digital notification system 102 can generate notifications tailored to a specific vehicle make and model. To illustrate, the digital notification system 102 can determine for a specific geographic location a set of vehicle makes, vehicle models, and vehicle years. In this manner, the digital notification system 102 can utilize the set of service vehicle type 306 (make, model, and year) to identify the aforementioned patterns for the same vehicle service types.

Additionally, the digital notification system 102 can monitor vehicle maintenance costs 308. For example, the digital notification system 102 accesses current and historical invoices from service management computing devices to determine vehicle maintenance costs 308. In particular, vehicle maintenance costs 308 includes values for labor, parts, and other vehicle maintenance operations. Further, the digital notification system 102 via the monitoring system 300 can monitor automotive shops, manufacturers, and vehicle records indicating part availability. Moreover, by determining vehicle maintenance costs 308, the digital notification system 102 can provide notifications to a client device informed by price and cost contextual factors.

As illustrated, FIG. 3 also shows the digital notification system 102 monitoring maintenance patterns 310. For example, maintenance patterns 310 includes the type, amount, timing, and/or frequency of various services for vehicles. For example, the digital notification system 102 can interact with service management computing devices of various service stations to determine vehicle service events over time and the reason for the vehicle service events. The digital notification system 102 can then determine patterns, such as the frequency of various service maintenance tasks for a particular vehicle type or context. To illustrate, determining maintenance patterns 310 can include replacing vehicle brakes after a certain number of miles for certain vehicles or driver types, or replacing vehicle coolant after a certain number of miles. Moreover, by determining maintenance patterns 310, the digital notification system 102 can provide notifications conforming with determined maintenance trends specific to the maintenance patterns of particular vehicles, locations, or driving styles.

As also illustrated, FIG. 3 shows the digital notification system 102 monitoring vehicle accident information 312. For example, vehicle accident information 312 includes a number, frequency, severity, and type of collisions or accidents. The digital notification system 102 can determine the vehicle accident information 312 by interacting with service management computing devices that include digital records indicating replaced parts or vehicle operations performed for a specific type of vehicle in response to a vehicle accident. In particular, the vehicle accident information 312 can include a report of average costs for a specific type of vehicle following an accident. To illustrate, for a specific service vehicle type 306, the vehicle accident information 312 can indicate that the average cost for repair is around $1000.

As mentioned above, in one or more embodiments, the digital notification system 102 determines transportation matching features. As illustrated, FIG. 4 shows the digital notification system 102 via the transportation matching system 106 monitoring and determining various transportation matching features from transportation matching devices. For example, FIG. 4 shows the digital notification system 102 monitoring various client applications or in-vehicle sensors to determine transportation matching features.

As just mentioned, in one or more embodiments, the digital notification system 102 utilizes the client application to monitor various transportation matching features. For example, the digital notification system 102 monitors requests sent and received via the client application (e.g., the transportation matching application), and real-time transportation data detected up via the client application. Thus, the digital notification system 102 can determine pickup times, pickup locations, drop off times, drop off locations, routes, locations, stops, traffic patterns, etc. In addition, the digital notification system 102 can utilize internal sensors (e.g., accelerometers, gyroscopes, magnetometers, global positioning units, biometric sensors, radar sensors, LiDAR sensors, barometers, light sensors, or proximity sensors) within a mobile computing device to determine transportation matching information. The digital notification system 102 can also utilize camera devices of provider/requester devices to determine transportation matching information. As also mentioned, in one or more embodiments, the digital notification system 102 utilizes sensitive sensors (e.g., accelerometers, gyroscopes, etc.) appended to the vehicle to detect similar information. For example, the sensor attached to the vehicle includes capabilities to pick up driving patterns and routes. In particular, the sensor receives driving pattern and route data via the sensor and transmits the data to the digital notification system 102.

As mentioned above, the transportation matching system 106 and the monitoring system 400 monitor transportation matching features. For example, the digital notification system 102 via the monitoring system 400 can monitor requester devices, provider devices, and transportation requests. In some implementations, the transportation matching system 106 utilizes fleet devices that are temporarily utilized by providers to provide transportation matching transportation services and personal transportation. The digital notification system 102 can also determine transportation matching information for these fleet vehicles, while providing transportation matching transportation services or personal transportation.

As illustrated, FIG. 4 shows the digital notification system 102 monitoring transportation matching driving route patterns 402. For example, the transportation matching driving route patterns 402 include driving routes for transportation requests. In particular, the transportation matching driving route patterns 402 can include geographic locations (e.g., pickup locations, drop locations, or routes), times, and frequencies for providing or receiving transportation services. Thus, for example, transportation matching driving route patterns 402 include identifying commonly traversed routes for individual provider/requester devices or a collection of provider/requester devices. To illustrate, transportation matching driving route patterns 402 can include the digital notification system 102 determining that the public library to the international airport is a commonly traversed route on Saturday morning (e.g., for provider/requesters generally or for a particular class or subset of providers/requesters). Furthermore, the digital notification system 102 can utilize the transportation matching driving route patterns 402 to determine a likelihood of an individual provider device receiving a request to drive a certain transportation matching route or the likelihood of an individual requester device transmitting a request traversing a certain transportation matching route.

As mentioned, FIG. 4 also shows the digital notification system 102 monitoring transportation matching vehicle types 404. For example, transportation matching vehicle types 404 include vehicle makes, vehicle models, and vehicle years utilized for transportation matching within a transportation matching ecosystem. In particular, the digital notification system 102 identifies transportation matching vehicle types 404 to determine patterns between quality of driving, requester satisfaction, transportation matching driving route patterns, and maintenance patterns. To illustrate, the digital notification system 102 can determine the transportation matching vehicle types 404 for determining whether a specific client device prefers certain transportation matching vehicle types over others.

Furthermore, FIG. 4 shows the digital notification system 102 monitoring transportation matching vehicle telematics data 406. For example, the transportation matching vehicle telematics data 406 includes data from various sensors associated with transportation services. For example, transportation matching vehicle telematics data 406 includes information from sensors received from provider devices, requester devices, or other in-vehicle sensors. Thus, for example, the digital notification system 102 can determine vehicle acceleration habits, braking habits, proclivity towards sharp-turns, and other vehicle driving habits based on transportation matching vehicle telematics data 406 from accelerometers, gyroscopes, magnetometers, global positioning units, biometric sensors, radar sensors, or LiDAR sensors of a provider device, requester device, or other in-vehicle device.

As also illustrated, FIG. 4 shows the digital notification system 102 monitoring transportation matching driver ratings 408. For example, the transportation matching driver ratings 408 include requester devices assigning a satisfaction rating to a provider device. In particular, upon completion of a transportation matching event, a requester device can rate the provider device that provided the transportation matching event. To illustrate, the digital notification system 102 can utilize transportation matching driver ratings 408 to determine patterns between transportation matching vehicle types, transportation matching vehicle telematics data, vehicle maintenance patterns, and other features. In doing so, the digital notification system 102 generates notifications based on the transportation matching driver ratings 408. In some implementations, the digital notification system 102 can also identify transportation matching rider ratings (e.g., ratings of riders from provider devices) and utilize the transportation matching rider ratings to generate digital notifications.

Additionally, FIG. 4 shows the digital notification system 102 monitoring provider transportation matching schedules 410. For example, the provider transportation matching schedules 410 includes a schedule of a provider device providing transportation services. For instance, the digital notification system 102 can monitor when provider devices are online or offline, when provider devices are in different modes (e.g., a limited availability mode to travel to a particular driver-selected destination or a high-value mode limited to rides of a particular value), and locations traversed or visited over time. To illustrate, the digital notification system 102 can determine provider transportation matching schedules 410 to identify busy locations and times within a geographic location and/or contextualize notifications to match provider transportation matching schedules 410. The digital notification system 102 can also monitor requester transportation matching schedules (e.g., times, locations, modes such as a high-value or time-priority request, of rider devices) and utilize the requester transportation matching schedules to generate digital notifications.

Further, FIG. 4 shows the digital notification system 102 monitoring a number of transportation matching requester devices 412 for a geographic location and a number of transportation matching provider devices 414 for a geographic location. In particular, the digital notification system 102 can monitor transportation matching requester devices 412 and transportation matching provider devices 414 to determine traffic or device imbalances within a specific geographic location. Based on monitoring the transportation matching requester devices 412 and transportation matching provider devices 414, the digital notification system 102 can generate tailored notifications.

As mentioned, the digital notification system 102 can train a notification model. For example, FIG. 5 illustrates the digital notification system 102 training a notification machine learning model 506. In particular, the digital notification system 102 receives various training input features, generates a predicted result, and applies a loss function to train the notification machine learning model 506.

As illustrated, FIG. 5 shows the notification machine learning model 506 receiving various inputs. For example, FIG. 5 shows the notification machine learning model 506 receiving as inputs vehicle service features 500, client specific vehicle service features 501, transportation matching features 504, client specific transportation matching features 503, and a notification 502. In particular, the digital notification system 102 receives via the notification machine learning model 506 the various features as inputs and generates various notifications with corresponding predicted interaction probabilities 508. Furthermore, the digital notification system 102 performs an act of monitoring client device interactions with notifications. To illustrate, the digital notification system 102 monitors the client device interactions with notifications by determining whether a client device views a notification or dismisses a notification.

In one or more embodiments, based on the digital notification system 102 monitoring the client device interactions with notifications, the digital notification system 102 performs an act 512 of comparing the interaction probabilities 508 with monitored interactions 510 (e.g., the actual result of whether a client device interacted with a notification). In doing so, the digital notification system 102 via the notification machine learning model 506 determines differences between the predicted interaction probabilities 508 for a notification with the monitored interactions 510. In particular, the digital notification system 102 applies a loss function 514 as part of an act 512 of comparing the predicted interaction probabilities 508 and the monitored interactions 510. The digital notification system 102 can apply various loss functions including at least one of an L1 loss function (least absolute deviations), an L2 loss function (least square errors), a cross-entropy loss function, or a mean squared error loss function. In particular, after applying the loss function 514, as shown in FIG. 5, the digital notification system 102 back propagates the loss to modify parameters of the notification machine learning model 506.

Although FIG. 5 illustrates generating the predicted interaction probabilities 508, the digital notification system 102 can generate a variety of predicted results and compare those predicted results with monitored/ground truth results. Thus, for example, instead of predicting an interaction probability, the digital notification system 102 can generate a predicted vehicle risk or a predicted maintenance need. The digital notification system 102 can utilize a ground truth vehicle risk or ground truth maintenance to determine the loss function and train the machine learning model.

In one or more embodiments, the digital notification system 102 utilizes a Markov reward model for training and determining notifications to generate. In particular, the digital notification system 102 utilizes a state for a client device with various combinations of features (e.g., vehicle service features 500, client specific vehicle service features 501, transportation matching features 504, client specific transportation matching features 503, and notification 502) and a state for a client device with the various combinations of features interacting with a notification. Further, for each of the notifications, the Markov reward model assigns a transition probability of the client device interacting with the notification. Additionally, the digital notification system 102 via the Markov reward model monitors actual interactions of the client device and the notifications. Based on the actual interactions (e.g., the monitored interactions 510), the Markov reward model adjusts transition probabilities. Accordingly, the trained Markov reward model based on receiving as input certain features, generates a notification with the highest determined transition probability.

Although many of the foregoing examples reflect generating vehicle managing notifications, the digital notification system 102 can also utilize the models described in relation to FIG. 5 to generate other notifications. For example, the digital notification system 102 can utilize heuristic models or optimization models to analyze vehicle service features and transportation matching features to generate transportation recommendations and/or transportation match notifications. Thus, for example, the digital notification system 102 can optimize an overall cost metric to recommend to a client device whether to utilize a personal vehicle, a vehicle operated by a provider device, a bike, a scooter, or a transit vehicle. For instance, the digital notification system 102 can analyze vehicle service features and transportation matching features to determine an overall cost between driving a personal vehicle relative to a transportation matching vehicle based on the need to service vehicle, the safety of the current vehicle status, current costs of transportation matching vehicles, time/cost of parking a personalized vehicle and walking/traveling from the personal vehicle, available transportation vehicles relative to preferences in historical transportation matching vehicles, etc. The digital notification system 102 can make similar determinations for other transportation vehicles or modalities (e.g., bike, scooter, or transit vehicles). Based on such an optimization approach, the digital notification system 102 can generate a transportation recommendation for a corresponding vehicle (e.g., the vehicle with the lowest overall costs).

Similarly, the digital notification system 102 can utilize a heuristic or optimization approach to generate a transportation match notification. For example, the digital notification system 102 can analyze features that include vehicle service features and transportation matching features to select a provider device from a pool of provider devices. To illustrate, the digital notification system 102 can analyze maintenance history/safety of the pool of provider devices (e.g., a provider device has older tires and should not service a request to a snowy area), maintenance needs/schedules of the pool of provider devices (e.g., a first provider device needs to take a break to obtain service and thus cannot fill a transportation request with a long wait time), service maintenance times (e.g., a provider device is about to come online because their oil change is complete in five minutes and therefore, the provider device may be an efficient match for a particular transportation request), vehicle service availability (e.g., a vehicle service slot recently opened in a particular area, so the provider device in that area will be using the vehicle service station rather than responding to a transportation request), or other features, in addition to anticipated driving times, wait times, or transportation cost. The digital notification system 102 can analyze these features, determine an overall cost, and generate a transportation match based on the overall cost.

The digital notification system 102 can also train a machine learning model to generate transportation recommendations and/or transportation match notifications. For example, in addition to the monitored interactions 510, the digital notification system 102 can utilize other features or ground truths to train the notification machine learning model 506 to generate transportation recommendations or transportation match notifications. To illustrate, for transportation notifications, the digital notification system 102 can generate a transportation recommendation (e.g., to utilize a personal vehicle or to utilize a transportation matching vehicle). The digital notification system 102 can then analyze monitored interactions to determine if the client device follows the transportation recommendation (or not). Thus, the digital notification system 102 can learn over time to make improved notifications.

Similarly, for transportation match notifications, the digital notification system 102 can predict wait times, efficiency metrics, conversion/cancellation rates, or other metrics. The digital notification system 102 can compare these predicted metrics with measured metrics (e.g., actual wait times, efficiency metrics, conversion/cancellation rates). The digital notification system 102 can thus, over time, learn to associate vehicle service features and transportation matching features with features or characteristics of efficient or improved transportation matches. The digital notification system 102 can utilize a trained machine learning model to predict these metrics and generate recommended transportation matches (e.g., assign the transportation match to the provider device with the highest or best metrics).

As mentioned previously, the digital notification system 102 generates notifications based on vehicle service features and transportation matching features. As shown in FIG. 6, the digital notification system 102 identifies vehicle service features 600, client specific vehicle service features 604, transportation matching features 602, and client specific transportation matching features 606. Furthermore, FIG. 6 shows the digital notification system 102 utilizing the notification model 608 to select notifications. For example, the notification model 608 generates interaction probabilities (or other scores) and selects a vehicle notification based on the interaction probability. Moreover, as shown, the digital notification system 102 also performs an act 610 of providing notifications to client devices. In particular, FIG. 6 illustrates the digital notification system 102 providing notifications 612a-612f.

As mentioned previously in regard to FIGS. 3 and 4, the digital notification system 102 utilizes various vehicle service features 600 and transportation matching features 602 to generate notifications. For example, the digital notification system 102 can receive as inputs to the notification model 608 a transportation matching driver rating (e.g., transportation matching driver rating 408 described in FIG. 4), a service vehicle type (e.g., service vehicle type 306 described in FIG. 3), and vehicle maintenance patterns (e.g., maintenance patterns 310 described in FIG. 3). Based on the aforementioned features, the digital notification system 102 can generate a vehicle service recommendation, e.g., a notification relating to vehicle service. Indeed, the notification model 608 can learn (based on analyzing vehicle maintenance patterns, service vehicle type, and the transportation matching driver ratings) that a low transportation matching driver rating in combination with a particular vehicle type (e.g., a mid-size sedan) results in an early need for an oil change relative to other drivers and vehicle types. Thus, the notification based on the aforementioned features can indicate the notification 612a of “get an oil change at this location next week.” Thus, the digital notification system 102 utilizes the transportation matching driver rating, vehicle type, and vehicle service features to generate tailored notifications to a specific client device.

In one or more embodiments, the digital notification system 102 analyzes transportation matching vehicle types, and vehicle maintenance costs. Based on the aforementioned features, the digital notification system 102 generates a notification relating to purchasing another vehicle. Indeed, the notification model 608 can learn that a requester device that frequently utilizes or requests a particular vehicle in combination with a significant difference in vehicle maintenance costs between a current vehicle and a new vehicle often results in a vehicle change (e.g., by analyzing changes in vehicle type over time for vehicle owners at vehicle service stations). Thus, the digital notification system 102 can generate a notification (e.g., as shown in the notification 612b) of “consider upgrading your vehicle, click here for more information!” Thus, the digital notification system 102 can analyze transportation matching features (e.g., vehicle frequently utilized in transportation matching) together with vehicle service features (e.g., differences in maintenance costs) to surface a particular notification (e.g., that a requester device may potentially have interest in purchasing another vehicle).

Continuing the foregoing example, the digital notification system 102 can also determine other patterns from transportation matching or vehicle service features in generating the notification 612b. For example, the digital notification system 102 can determine that a provider device has a similar transportation matching driver rating to other providers that drive a particular car. In response, the digital notification system 102 can surface the notification regarding the particular car. Indeed, the digital notification system 102 can learn patterns from a variety of different combinations of transportation matching and vehicle service features described herein.

In one or more embodiments, the digital notification system 102 receives as inputs vehicle accident information, vehicle maintenance patterns, vehicle maintenance costs, and transportation matching driver ratings to generate an offer notification. Indeed, the notification model 608 can analyze these signals to learn that a high transportation matching driver rating results in reduced accidents and maintenance costs. Accordingly, the digital notification system 102 can surface a notification that includes an offer (such as a vehicle insurance offer with reduced rates). In particular, based on the aforementioned features, the digital notification system 102 generates a notification that indicates notification 612c of “you qualify for a great offer!” Thus, the digital notification system 102 utilizes the maintenance patterns, costs, and ratings to determine the maintenance habits of highly rated transportation matching providers and presents offers related to vehicle parts or vehicle insurance.

Furthermore, in other instances, the digital notification system 102 can generate additional offer notifications. For example, the digital notification system 102 can generate an offer notification that indicates that a user of the client device can save a specified amount of money by replacing a certain vehicle part. In particular, the digital notification system 102 can analyze transportation matching telematics data, transportation matching routes, vehicle maintenance patterns, and vehicle maintenance costs to learn that certain transportation matching patterns and routes result in needed part replacements and learn fluctuations in cost for replacement for those replacements. Based on these learned features, the digital notification system 102 can generate an offer notification indicating a recommendation for timing of a particular part or service as well as an amount that the provider device can save.

In one or more embodiments, the digital notification system 102 receives as inputs transportation matching driving route patterns and vehicle service station availability. Based on the aforementioned features, the digital notification system 102 can generate a service recommendation corresponding with an automotive maintenance location. Indeed, the notification model 608 can learn traffic trends and commonly taken routes in combination with available vehicle service stations to make recommendations for utilizing a convenient and practical vehicle service station location. To illustrate, the notification based on the aforementioned features can reflect the notification 612d of “use this location for your maintenance.”

In one or more embodiments, the digital notification system 102 analyzes patterns between provider transportation matching schedule, vehicle service station availability, and down-times. In particular, the digital notification system 102 based on receiving the aforementioned features generates a notification focused on a maintenance recommendation tailored to a specific time and location. Indeed, the notification model 608 can learn from particular down-times in combination with provider transportation matching schedules and vehicle station availability to recommend a particular location and/or time for maintenance. Specifically, the digital notification system 102 based on the aforementioned features generates a notification akin to notification 612e of “You typically don't provide transportation matching on Tuesday mornings, get a tune up at this location. It'll only take 2 hours!” To illustrate, the digital notification system 102 utilizes the provider transportation matching schedule to determine individual patterns during the week along with down-times for vehicle service. In doing so, the digital notification system 102 can determine an approximate amount of time spent for servicing a vehicle during a recommended time of day.

In one or more embodiments, the digital notification system 102 analyze vehicle service station availability, provider transportation matching schedule, and transportation matching driving route patterns. Based on the aforementioned features, the digital notification system 102 also generates a vehicle maintenance notification based on schedule and location. Indeed, this notification is similar to the above-discussed recommendation for convenient and practical service station locations. However, in addition, the notification model 608 can learn free time within a provider transportation matching schedule in combination with vehicle service station availability and transportation matching driving route patterns to make tailored maintenance recommendations. In particular, as shown, the digital notification system 102 generates a notification like that of notification 612f “check out these options that match your schedule and location.” Specifically, the digital notification system 102 utilizes both provider transportation matching schedules and transportation matching driving route patterns for determining a likelihood of an individual provider receiving a request within a certain area.

Although the foregoing examples focus predominantly on vehicle management notifications, the digital notification system 102 can also generate other notifications, including transportation recommendations and/or transportation match notifications. Indeed, although not illustrated in FIG. 6, in one or more embodiments, the digital notification system 102 generates transportation recommendations. For example, the digital notification system 102 analyzes transportation matching features and vehicle service features to generate transportation recommendations. For instance, the digital notification system 102 generates the transportation recommendation based on the vehicle service features from the plurality of service management computing devices and the transportation matching features for the plurality of provider computing devices. In particular, the digital notification system 102 determines whether the requester computing device should utilize a personal vehicle or a set of transportation matching vehicles. Specifically, the vehicle for transportation matching includes a vehicle within the ridesharing ecosystem.

To illustrate, consider a client device corresponding to a user traveling to the airport for a flight. The digital notification system 102 can determine the intended destination (e.g., based on a calendar, email, or user input indicating the destination) and analyze transportation alternatives for traveling to the airport. The digital notification system 102 can consider transportation matching features and/or vehicle service features in selecting and recommending a particular transportation vehicle or modality. For example, the digital notification system 102 can analyze vehicle service features of a personal vehicle corresponding to the user and determine that the personal vehicle needs a time-consuming maintenance task and that there is availability at a local service station. In response, the digital notification system 102 can recommend utilizing a transportation matching vehicle (rather than the personal vehicle) so that the maintenance can be performed during the trip.

Similarly, the digital notification system 102 can analyze the time to park a personal vehicle, the cost of parking the personal vehicle, the time to walk from the personal vehicle to the airport, congestion at the airport, historical preferences of the user, the cost of other vehicles or modalities, the number of provider devices available, the number of requester devices available, a provider device, requester device balance metric (e.g., a comparison or relative ratio between provider devices and requester devices) to recommend a particular transportation vehicle or modality.

Thus, the digital notification system 102 can make transportation recommendations based on efficiency (e.g., the number of provider computing devices available in a specific geographic area), cost (e.g., the cost of utilizing ridesharing versus a personal vehicle), vehicle maintenance (e.g., the maintenance schedule of a personal vehicle or the vehicle upkeep of available ridesharing vehicles) and other features gleaned from vehicle service features and/or transportation matching features. In doing so, the digital notification system 102 generates a transportation recommendation.

Further as also mentioned, the digital notification system 102 generates transportation match notifications. For example, the transportation match notifications include the digital notification system 102 intelligently determining from a pool of available provider computing devices a specific provider computing device for a transportation match with the requester computing device. In particular, the digital notification system 102 generates the transportation match notification based on the vehicle service features from the plurality of service management computing devices and the transportation matching features for the plurality of provider computing devices. For instance, similar to above, the digital notification system 102 analyzes vehicle upkeep (e.g., maintenance schedules, accident data, etc.) between each of the available provider computing devices from the pool of available providers, and requester preferences (e.g., transportation matching features such as rating of providers as related to vehicle type), or other features to generate a transportation match notification.

Additionally, or alternatively, the digital notification system 102 can analyze the number of transportation matching providers (e.g., number of transportation matching provider devices 414), the number of transportation matching requesters (e.g., number of transportation matching requester devices 412), and the vehicle service station availability. Based on the aforementioned features, the digital notification system 102 can generate a notification to utilize a certain automotive shop location based on potential ratio of provider devices and requester devices within an area. Indeed, the notification model 608 can provide a notification to go to a certain location for maintenance based on detecting a low number of transportation matching requester devices in combination with vehicle service station availability.

Although the above description of FIG. 6 includes various example combination sets of vehicle service features 600 and transportation matching features 602 to surface various notifications, in one or more embodiments, the digital notification system 102 can utilize any combination of vehicle service features, client specific vehicle service features, transportation matching features, and client specific transportation matching features discussed herein to generate notifications. For example, in addition to the described notifications, the digital notification system 102 can utilize transportation matching pricing along with additional transportation matching features and vehicle service features to generate a notification. Indeed, the notification model 608 can learn that low transportation matching pricing in combination with other transportation matching features and vehicle service features results in recommendations to go to certain maintenance locations at certain times. In particular, the notification can include a recommendation to perform an action during a particular time of day based on the transportation matching pricing.

As mentioned above, the digital notification system 102 provides notifications for display on a graphical user interface of a client device. As illustrated, FIG. 7 shows a graphical user interface of a client device and a notification generated by the digital notification system 102 via a notification model. For example, FIG. 7 shows a client device 700 with a first graphical user interface 702. In particular, the first graphical user interface 702 includes a map and a search element for selection of a location for a transportation matching request. Furthermore, the first graphical user interface 702 also shows a bottom tool bar with various options. Specifically, FIG. 7 shows a notification element 704 with an indicator 706 that shows a notification. Furthermore, FIG. 7 shows a selection 708 of the notification element 704 in the first graphical user interface 702.

In one or more embodiments, based on the selection 708 of the notification element 704, the digital notification system 102 transitions from the first graphical user interface 702 to a second graphical user interface 710. In particular, on the second graphical user interface 710, the digital notification system 102 shows a notification 712 with an interactive element 714. Specifically, as already discussed, the digital notification system 102 utilizes the notification model to generate the notification 712. Based on user interaction with the interactive element 714, the digital notification system 102 provides additional information corresponding to the notification 712. Furthermore, in one or more embodiments, the second graphical user interface 710 also provides for an option for editing specific client device information 716.

As mentioned above, the graphical user interfaces shown in FIG. 7 provides accuracy, efficiency, and flexibility improvements relative to conventional systems. Specifically, the digital notification system 102 draws from transportation matching features and vehicle service features to generate the interactive element 714 within a single graphical user interface within a transportation matching application. Thus, rather than having to utilize multiple applications and interfaces to track mileage, maintenance history, service stations, and transportation needs, the digital notification system 102 provides an efficient user interface within a transportation matching application that significantly reduces time and resources.

The components of the digital notification system 102 can include software, hardware, or both. For example, the components of the digital notification system 102 can include one or more instructions stored on a computer-readable storage medium and executable by processors of one or more computing devices. When executed by the one or more processors, the computer-executable instructions of the digital notification system 102 can cause the computing device to perform the methods described herein. Alternatively, the components of the digital notification system 102 can comprise hardware, such as a special purpose processing device to perform a certain function or group of functions. Additionally, or alternatively, the components of the digital notification system 102 can include a combination of computer-executable instructions and hardware.

Furthermore, the components of the digital notification system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the digital notification system 102 may be implemented as part of a stand-alone application on a personal computing device or a mobile device. Alternatively, or additionally, the components of the digital notification system 102 may be implemented in any application that generates and provides notifications, but not limited to, various applications.

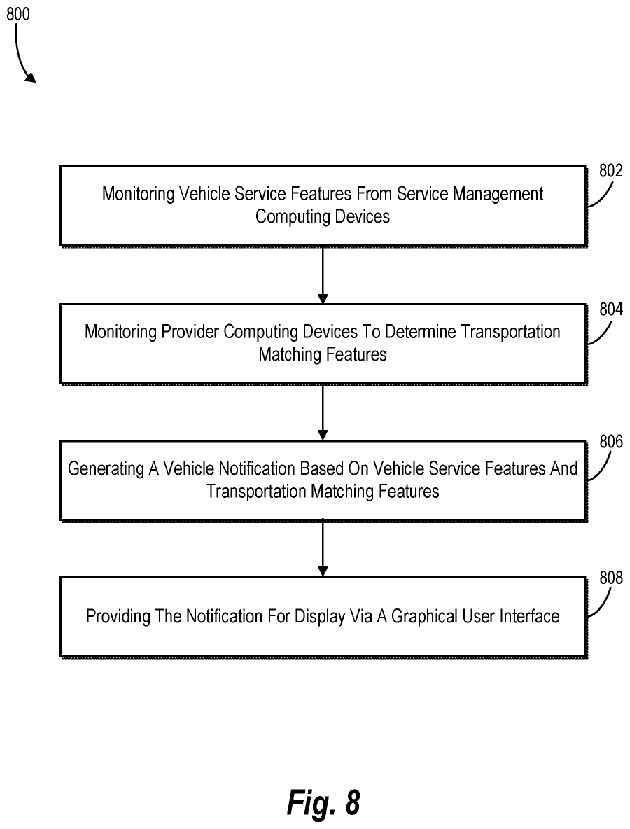

FIGS. 1-7, the corresponding text, and the examples provide a number of different systems, methods, and non-transitory computer readable media for generating and providing notifications. In addition to the foregoing, embodiments can also be described in terms of flowcharts comprising acts for accomplishing a particular result. For example, FIG. 8 illustrates a flowchart of an example sequence of acts in accordance with one or more embodiments.

While FIG. 8 illustrates acts according to some embodiments, alternative embodiments may omit, add to, reorder, and/or modify any of the acts shown in FIG. 8. The acts of FIG. 8 can be performed as part of a method. Alternatively, a non-transitory computer readable medium can comprise instructions, that when executed by one or more processors, cause a computing device to perform the acts of FIG. 8. In still further embodiments, a system can perform the acts of FIG. 8. Additionally, the acts described herein may be repeated or performed in parallel with one another or in parallel with different instances of the same or other similar acts.

FIG. 8 illustrates an example series of acts 800 for generating and providing notifications in accordance with one or more embodiments. As shown, the series of acts 800 includes an act 802 of monitoring vehicle service features from service management computing devices, an act 804 of monitoring provider computing devices to determine transportation matching features, an act 806 of generating a notification based on vehicle service features and transportation matching features, and an act 808 of providing the notification for display via a graphical user interface.

In one or more implementations, the act 802 further includes monitoring, vehicle service features from a plurality of service management computing devices, wherein the vehicle service features are based on vehicle data captured by the plurality of service management computing devices. Additionally, the act 802 also includes service vehicle types, vehicle accident information, or vehicle service station availability. In one or more implementations, the act 804 includes monitoring a plurality of provider computing devices, via a transportation matching application, to determine transportation matching features for the plurality of provider computing devices. The act 804 also includes monitoring a plurality of provider computing devices to determine transportation matching features further comprises monitoring at least one of transportation matching vehicle telematics data, transportation matching driver ratings, transportation matching vehicle types transportation matching driving route patterns, number of transportation matching provider devices for a geographic region, number of transportation matching requester devices for a geographic region, or provider transportation matching schedules. Moreover, the act 804 includes determining the transportation matching features comprises determining a provider transportation matching schedule corresponding with a provider computing device, determining vehicle service features comprises determining vehicle station availability, and generating the notification comprises generating at least one of an offer notification or a vehicle maintenance recommendation notification based on the provider transportation matching schedule and the vehicle service station availability.

In one or more embodiments, the act 806 includes generating, utilizing a notification model, a notification for a transportation matching application of a client device based on the vehicle service features from the plurality of service management computing devices and the transportation matching features for the plurality of provider computing devices. Furthermore, the act 806 also includes utilizing a machine learning model to generate the notification based on the vehicle service features and the transportation matching features. Moreover, the act 806 also includes generating the transportation recommendation by selecting between a personal vehicle corresponding to the client device or a set of transportation matching vehicles based on the vehicle service features from the plurality of service management computing devices and the transportation matching features for the plurality of provider computing devices. In addition, the act 806 includes generating the transportation match notification by selecting a provider computing device from a pool of provider computing devices based on the vehicle service features from the plurality of service management computing devices and the transportation matching features for the plurality of provider computing devices.

In one or more embodiments, the act 808 includes providing the notification for display via a graphical user interface of the transportation application on the client device, wherein the notification comprises at least one of: a vehicle management notification, a transportation recommendation, or a transportation match notification indicating a transportation match with a provider computing device. Additionally, the act 808 includes providing the notification via the graphical user interface to at least one of a requester computing device or a provider computing device.

In addition, the series of acts 800 includes monitoring a plurality of requester computing devices to determine the transportation matching features by determining a number of requester computing devices at a particular time, monitoring the vehicle service features by determining vehicle service station availability at the particular time, and generating the notification by generating the vehicle management notification based on the number of provider computing devices and the vehicle service station availability at the particular time.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 (e.g., the provider devices 108a-108n, the client device 112, or the server(s) 104) that may be configured to perform one or more of the processes described above. One will appreciate that the digital notification system 102 can comprise implementations of the computing device 900, including, but not limited to, the provider devices 108a-108n and/or the server(s) 104. As shown by FIG. 9, the computing device can comprise a processor 902, memory 904, a storage device 906, an I/O interface 908, and a communication interface 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, storage device 906 can comprise a non-transitory storage medium described above. The storage device 906 may include a hard disk drive (“HDD”), flash memory, a Universal Serial Bus (“USB”) drive or a combination of these or other storage devices.

The computing device 900 also includes one or more input or output interface 908 (or “I/O interface 908”), which are provided to allow a user (e.g., requester or provider) to provide input to (such as user strokes), receive output from, and otherwise transfer data to and from the computing device 900. These I/O interface 908 may include a mouse, keypad or a keyboard, a touch screen, camera, optical scanner, network interface, modem, other known I/O devices or a combination of such I/O interface 908. The touch screen may be activated with a stylus or a finger.

The I/O interface 908 may include one or more devices for presenting output to a user, including, but not limited to, a graphics engine, a display (e.g., a display screen), one or more output providers (e.g., display providers), one or more audio speakers, and one or more audio providers. In certain embodiments, interface 908 is configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 can provide one or more interfaces for communication (such as, for example, packet-based communication) between the computing device and one or more other computing devices 900 or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include a bus 912. The bus 912 can comprise hardware, software, or both that connects components of computing device 900 to each other.

FIG. 10 illustrates an example network environment 1000 of the transportation matching system 106. The network environment 1000 includes a client device 1006 (e.g., the provider devices 108a-108n or the client device 112, or an infotainment device), a transportation matching system 106, and a vehicle subsystem 1008 connected to each other by a network 1004. Although FIG. 10 illustrates a particular arrangement of the client device 1006, the transportation matching system 106, the vehicle subsystem 1008, and the network 1004, this disclosure contemplates any suitable arrangement of client device 1006, the transportation matching system 106, the vehicle subsystem 1008, and the network 1004. As an example, and not by way of limitation, two or more of client device 1006, the transportation matching system 106, and the vehicle subsystem 1008 communicate directly, bypassing network 1004. As another example, two or more of client device 1006, the transportation matching system 106, and the vehicle subsystem 1008 may be physically or logically co-located with each other in whole or in part.

Moreover, although FIG. 10 illustrates a particular number of client devices 1006, transportation matching system 106, vehicle subsystems 1008, and networks 1004, this disclosure contemplates any suitable number of client devices 1006, transportation matching system 106, vehicle subsystems 1008, and networks 1004. As an example, and not by way of limitation, network environment 1000 may include multiple client device 1006, transportation matching system 106, vehicle subsystems 1008, and/or networks 1004.

This disclosure contemplates any suitable network 1004. As an example, and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more networks 1004.

Links may connect client device 1006, digital notification system 102, and vehicle subsystem 1008 to network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client device 1006 may be an electronic device including hardware, software, or embedded logic components or a combination of two or more such components and capable of carrying out the appropriate functionalities implemented or supported by client device 1006. As an example, and not by way of limitation, a client device 1006 may include any of the computing devices discussed above in relation to FIG. 9. A client device 1006 may enable a network user at the client device 1006 to access network 1004. A client device 1006 may enable its user to communicate with other users at other client devices 1006.

In particular embodiments, the client device 1006 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1006 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1006 one or more Hyper Text Markup Language (“HTML”) files responsive to the HTTP request. The client device 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 106 may be a network-addressable computing system that can host a transportation matching network. The transportation matching system 106 may generate, store, receive, and send data, such as, for example, user-profile data, concept-profile data, text data, transportation request data, GPS location data, provider data, requester data, vehicle data, or other suitable data related to the transportation matching network. This may include authenticating the identity of providers and/or vehicles who are authorized to provide transportation services through the transportation matching system 106. In addition, the transportation matching system 106 may manage identities of service requesters such as users/requesters. In particular, the transportation matching system 106 may maintain requester data such as driving/riding histories, personal data, or other user data in addition to navigation and/or traffic management services or other location services (e.g., GPS services).

In particular embodiments, the transportation matching system 106 may manage transportation matching services to connect a user/requester with a vehicle and/or provider. By managing the transportation matching services, the transportation matching system 106 can manage the distribution and allocation of resources from vehicle systems and user resources such as GPS location and availability indicators, as described herein.

The transportation matching system 106 may be accessed by the other components of network environment 1000 either directly or via network 1004. In particular embodiments, the transportation matching system 106 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 106 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1006, or a transportation matching system 106 to manage, retrieve, modify, add, or delete, the information stored in data store.

In particular embodiments, the transportation matching system 106 may provide users with the ability to take actions on various types of items or objects, supported by the transportation matching system 106. As an example, and not by way of limitation, the items and objects may include transportation matching networks to which users of the transportation matching system 106 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 106 or by an external system of a third-party system, which is separate from transportation matching system 106 and coupled to the transportation matching system 106 via a network 1004.

In particular embodiments, the transportation matching system 106 may be capable of linking a variety of entities. As an example, and not by way of limitation, the transportation matching system 106 may enable users to interact with each other or other entities, or to allow users to interact with these entities through an application programming interfaces (“API”) or other communication channels.

In particular embodiments, the transportation matching system 106 may include a variety of servers, sub-systems, programs, modules, logs, and data stores. In particular embodiments, the transportation matching system 106 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile (e.g., provider profile or requester profile) store, connection store, third-party content store, or location store. The transportation matching system 106 may also include suitable components such as network interfaces, security mechanisms, load balancers, failover servers, management-and-network-operations consoles, other suitable components, or any suitable combination thereof. In particular embodiments, the transportation matching system 106 may include one or more user-profile stores for storing user profiles for transportation providers and/or transportation requesters. A user profile may include, for example, biographic information, demographic information, behavioral information, social information, or other types of descriptive information, such as interests, affinities, or location.

The web server may include a mail server or other messaging functionality for receiving and routing messages between the transportation matching system 106 and one or more client devices 1006. An action logger may be used to receive communications from a web server about a user's actions on or off the transportation matching system 106. In conjunction with the action log, a third-party-content-object log may be maintained of user exposures to third-party-content objects. A notification controller may provide information regarding content objects to a client device 1006. Information may be pushed to a client device 1006 as notifications, or information may be pulled from client device 1006 responsive to a request received from client device 1006. Authorization servers may be used to enforce one or more privacy settings of the users of the transportation matching system 106. A privacy setting of a user determines how particular information associated with a user can be shared. The authorization server may allow users to opt in to or opt out of having their actions logged by the transportation matching system 106 or shared with other systems, such as, for example, by setting appropriate privacy settings. Third-party-content-object stores may be used to store content objects received from third parties. Location stores may be used for storing location information received from client devices 1006 associated with users.

In addition, the vehicle subsystem 1008 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 1008 can include an autonomous vehicle—e.g., a vehicle that does not require a human operator. In these embodiments, the vehicle subsystem 1008 can perform maneuvers, communicate, and otherwise function without the aid of a human provider, in accordance with available technology.

In particular embodiments, the vehicle subsystem 1008 may include one or more sensors incorporated therein or associated thereto. For example, sensor(s) can be mounted on the top of the vehicle subsystem 1008 or else can be located within the interior of the vehicle subsystem 1008. In certain embodiments, the sensor(s) can be located in multiple areas at once—e.g., split up throughout the vehicle subsystem 1008 so that different components of the sensor(s) can be placed in different locations in accordance with optimal operation of the sensor(s). In these embodiments, the sensor(s) can include motion-related components such as an inertial measurement unit (“IMU”) including one or more accelerometers, one or more gyroscopes, and one or more magnetometers. The sensor(s) can additionally or alternatively include a wireless IMU (“WIMU”), one or more cameras, one or more microphones, or other sensors or data input devices capable of receiving and/or recording information relating to navigating a route to pick up, transport, and/or drop off a requester.

In particular embodiments, the vehicle subsystem 1008 may include a communication device capable of communicating with the client device 1006 and/or the digital notification system 102. For example, the vehicle subsystem 1008 can include an on-board computing device communicatively linked to the network 1004 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
monitoring vehicle service features from a plurality of service management computing devices, wherein the vehicle service features are based on vehicle data captured by the plurality of service management computing devices;
monitoring a plurality of provider computing devices, via a transportation matching application, to determine transportation matching features for the plurality of provider computing devices;
generating, utilizing a notification model, a notification for a transportation application of a client device based on the vehicle service features from the plurality of service management computing devices and the transportation matching features for the plurality of provider computing devices; and
providing the notification for display via a graphical user interface of the transportation application on the client device, wherein the notification comprises at least one of: a vehicle management notification, a transportation recommendation, or a transportation match notification indicating a transportation match with a provider computing device.

2. The computer-implemented method of claim 1, wherein generating, utilizing the notification model, the notification further comprises utilizing a machine learning model to generate the notification based on the vehicle service features and the transportation matching features.

3. The computer-implemented method of claim 1, further comprising:
monitoring a plurality of requester computing devices to determine the transportation matching features by determining a number of requester computing devices at a particular time;
monitoring the vehicle service features by determining vehicle service station availability at the particular time; and
generating the notification by generating the vehicle management notification based on the number of requester computing devices and the vehicle service station availability at the particular time.

4. The computer-implemented method of claim 1, further comprising: determining, the vehicle service features by determining at least one of vehicle maintenance patterns, vehicle maintenance costs, vehicle repair down-times, service vehicle types, vehicle accident information, or vehicle service station availability.

5. The computer-implemented method of claim 1, wherein monitoring a plurality of provider computing devices to determine transportation matching features further comprises monitoring at least one of transportation matching vehicle telematics data, transportation matching driver ratings, transportation matching vehicle types transportation matching driving route patterns, number of transportation matching provider devices for a geographic region, number of transportation matching requester devices for a geographic region, or provider transportation matching schedules.

6. The computer-implemented method of claim 1, wherein:
determining the transportation matching features comprises determining a provider transportation matching schedule corresponding with a provider computing device;
determining vehicle service features comprises determining vehicle service station availability; and
generating the notification comprises generating the vehicle management notification based on the provider transportation matching schedule and the vehicle service station availability.

7. The computer-implemented method of claim 1, wherein generating the notification comprises generating the transportation recommendation by selecting between a personal vehicle corresponding to the client device or a set of transportation matching vehicles based on the vehicle service features from the plurality of service management computing devices and the transportation matching features for the plurality of provider computing devices.

8. The computer-implemented method of claim 1, wherein generating the notification comprises generating the transportation match notification by selecting a provider computing device from a pool of provider computing devices based on the vehicle service features from the plurality of service management computing devices and the transportation matching features for the plurality of provider computing devices.

9. A system comprising:
at least one processor; and
a non-transitory computer readable storage medium comprising instructions that, when executed by the at least one processor, cause the system to:
monitor, vehicle service features from a plurality of service management computing devices, wherein the vehicle service features are based on vehicle data captured by the plurality of service management computing devices;
monitor a plurality of provider computing devices, via a transportation matching application, to determine transportation matching features for the plurality of provider computing devices;
generate, utilizing a notification model, a notification for a transportation application of a client device based on the vehicle service features from the plurality of service management computing devices and the transportation matching features for the plurality of provider computing devices; and
provide the notification for display via a graphical user interface of the transportation application on the client device, wherein the notification comprises at least one of: a vehicle management notification, a transportation recommendation, or a transportation match notification indicating a transportation match with a provider computing device.

10. The system of claim 9, further comprises instructions that, when executed by the at least one processor, cause the system to: utilize a machine learning model to generate the notification based on the vehicle service features and the transportation matching features.

11. The system of claim 9, further comprising instructions that, when executed by the at least one processor, cause the system to:
monitor a plurality of requester computing devices to determine the transportation matching features by determining a number of requester computing devices at a particular time;
monitor the vehicle service features by determining vehicle service station availability at the particular time; and
generate the notification by generating the vehicle management notification based on the number of requester computing devices and the vehicle service station availability at the particular time.

12. The system of claim 9, further comprising instructions that, when executed by the at least one processor, cause the system to determine, the vehicle service features by determining at least one of vehicle maintenance patterns, vehicle maintenance costs, vehicle repair down-times, determining, vehicle service features further comprises determining at least one of service vehicle types, vehicle accident information, or vehicle service station availability.

13. The system of claim 9, further comprising instructions that, when executed by the at least one processor, cause the system to monitor a plurality of provider computing devices to determine transportation matching features further comprises monitoring at least one of transportation matching vehicle telematics data, transportation matching driver ratings, transportation matching vehicle types transportation matching driving route patterns, number of transportation matching provider devices for a geographic region, number of transportation matching requester devices for a geographic region, or provider transportation matching schedules.

14. The system of claim 11, further comprising instructions that, when executed by the at least one processor, cause the system to:
determine a provider transportation matching schedule corresponding with a provider computing device;
determine vehicle station availability; and
generate the vehicle management notification based on the provider transportation matching schedule and the vehicle service station availability.

15. The system of claim 11, further comprising instructions that, when executed by the at least one processor, cause the system to generate the transportation recommendation by selecting between a personal vehicle corresponding to the client device or a set of transportation matching vehicles based on the vehicle service features from the plurality of service management computing devices and the transportation matching features for the plurality of provider computing devices.

16. A non-transitory computer readable storage medium comprising instructions that, when executed by at least one processor, cause the at least one processor to:
monitor, vehicle service features from a plurality of service management computing devices, wherein the vehicle service features are based on vehicle data captured by the plurality of service management computing devices;
monitor a plurality of provider computing devices, via a transportation matching application, to determine transportation matching features for the plurality of provider computing devices;
generate, utilizing a notification recommendation model, a notification for a transportation application of a client device based on the vehicle service features from the plurality of service management computing devices and the transportation matching features for the plurality of provider computing devices; and
provide the notification for display via a graphical user interface of the transportation application on the client device, wherein the notification comprises at least one of: a vehicle management notification, a transportation recommendation, or a transportation match notification indicating a transportation match with a provider computing device.

17. The non-transitory computer readable storage medium of claim 16, further comprising instructions that, when executed by the at least one processor, cause the at least one processor to utilize a machine learning model to generate the notification based on the vehicle service features and the transportation matching features.

18. The non-transitory computer readable storage medium of claim 16, further comprising instructions that, when executed by the at least one processor, cause the at least one processor to:
monitor a plurality of requester computing devices to determine the transportation matching features by determining a number of requester computing devices at a particular time;
monitor the vehicle service features by determining vehicle service station availability at the particular time; and
generate the notification by generating the vehicle management notification based on the number of requester computing devices and the vehicle service station availability at the particular time.

19. The non-transitory computer readable storage medium of claim 16, further comprising instructions that, when executed by the at least one processor, cause the at least one processor to determine, the vehicle service features by determining at least one of vehicle maintenance patterns, vehicle maintenance costs, vehicle repair down-times, determining, vehicle service features further comprises determining at least one of service vehicle types, vehicle accident information, or vehicle service station availability.

20. The non-transitory computer readable storage medium of claim 16, further comprising instructions that, when executed by the at least one processor, cause the at least one processor to monitor at least one of transportation matching vehicle telematics data, transportation matching driver ratings, transportation matching vehicle types transportation matching driving route patterns, number of transportation matching provider devices for a geographic region, number of transportation matching requester devices for a geographic region, or provider transportation matching schedules.
